(19) United States
(12) Patent Application Publication
(10) Pub. No.: US 2002/0010622 A1
(43) Pub. Date: Jan. 24, 2002

(54) System and method capable of appropriately managing customer information and computer-readable recording medium having customer information management program recorded therein

(76) Inventors: Fumino Okamoto, Osaka (JP); Yuichi Kawakami, Itami-Shi (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/904,528

(22) Filed: Jul. 16, 2001

(30) Foreign Application Priority Data
Jul. 18, 2000 (JP) 2000-217646(P)
Jul. 18, 2000 (JP) 2000-217647(P)
Jul. 18, 2000 (JP) 2000-217672(P)

(51) Int. Cl. G06F 17/60

(52) U.S. Cl. 705/10

(57) ABSTRACT

In a customer information management system a customer coming to a shop is image-sensed with a camera and the image information is used to automatically determine an attribute of the customer. Furthermore the image information is also referred to to count how often the customer comes to the shop, to determine whether the customer is a regular customer or a new customer. Furthermore there is also recorded information of customers leaving the shop without buying anything. Thus a customer attribute can automatically be determined and information can be improved in reliability, and a marketing strategy considering how often customers come to the shop, a marketing strategy for non-purchasers, and other similar strategies can also be developed.

This application is based on Applications Nos. 2000-217646, 2000-217647, and 2000-217672 filed in Japan, the contents of which are hereby incorporated by reference.

### BACKGROUND OF THE INVENTION

1. Field of the Invention

The present invention relates generally to customer information management systems and methods and computer-readable recording media having a customer information management program recorded therein, and particularly to customer information management systems and methods correlating an item purchased by a customer and an attribute of the customer with each other for management and computer-readable recording media having a customer information management program recorded therein.

2. Description of Related Art

Conventionally in convenience stores, supermarkets and the like a customer information management system has been used to correlate attributes such as sex and age of a customer having purchased an item and the data of the item with each other to store them in a database. In such a system, information in a database is used to provide various data analyses and a result thereof is used to develop a strategy to increase sales of items.

For example, if an age bracket, a sex and the like of customers purchasing an item can be determined the item associated with the attributes of the customers can be more offered and thus more purchased by the customers.

Such a database as described above, however, is typically configured by attributes of customers directly entered by a clerk at a cash desk. This disadvantageously results in the database storing inaccurate information; an attribute of a purchaser (a customer) is determined through a perception of a person entering the attribute information and it can thus be determined differently from person to person as people have different perceptions. Thus the purchaser attribute data stored has variation and is thus inaccurate.

Furthermore, entering such information is also time-consuming and cumbersome. In particular, if the information is entered in a hurry it can be entered incorrectly, resulting in further inaccuracy of the data.

Furthermore such a database as described above does not include information of shoppers just browsing through a shop and leaving the shop without purchasing an item, i.e., non-purchasers. As such, if such data is analyzed and a result is obtained, the result would not be useful in developing a strategy urging non-purchasers to buy items.

Furthermore the database as described above cannot provide information on whether a customer having purchased an item is a regular customer or a new customer. As such, if such data is analyzed and a result is obtained, it cannot provide the ratio of new customers and regular customers, the actual numbers of new customers and regular customers, and the like and it thus cannot be used to develop a strategy such as to shift new customers to regular customers.

An object of the present invention is to provide a customer information management system and method and a computer-readable recording medium having a customer information management program recorded therein, capable of creating an accurate database by alleviating an entry operation and also preventing a variation in determining an attribute of a customer.

Another object of the present invention is to provide a customer information management system and method and a computer-readable recording medium having a customer information management program recorded therein, capable of creating a database of information on a non-purchaser of an item to develop a marketing strategy to urge the non-purchaser to buy the item.

Still another object of the present invention is to provide a customer information management system and method and a computer-readable recording medium having a customer information management program recorded therein, capable of creating a database of information on how frequently a customer comes to a shop, to develop an appropriate marketing strategy corresponding to the customer's frequency of appearance in the shop.

### SUMMARY OF THE INVENTION

To achieve the above objects the present invention in one aspect provides a customer information management system including: a first acquisition block obtaining image information of a customer having purchased an item; an attribute determination block determining a first attribute of the customer from the image information obtained; a second acquisition block obtaining data of the item purchased by the customer; and a recording block recording the data of the item obtained and the first attribute of the customer determined, the data and the first attribute being correlated with each other.

In the present invention image information of a customer purchasing an item is used to determine an attribute of the customer. This can alleviate an operation entering information of the attribute of the customer. Furthermore the attribute can be determined free of variation as it is determined by referring to a uniform reference provided by image information. The attribute of the customer thus determined and data of an item purchased by the customer are correlated with each other and thus recorded.

Since the entry operation can be alleviated and the attribute of the customer can also be determined free of variation, the customer information management system can create an accurate database.

Preferably the recording block further records a second attribute of the customer, the second attribute being correlated with the data of the item obtained, the second attribute being determined through a human perception.

In the present invention the recording block further records a second attribute determined through a human perception and also correlated with the item. Thus, an attribute which can be determined through the human perception without a significant variation, such as whether the customer comes alone/in couples/together with his or her family, and which can hardly be determined automatically by processing an image, is determined through the human perception and the resultant decision is recorded. Thus the attribute can appropriately and thus more accurately be determined and thus recorded.

Preferably the customer information management system further includes an analysis block using the data of the item recorded and the attribute of the customer to provide a data analysis.

In the present invention data of an item and an attribute of a customer can be used to provide an appropriate data analysis for example for increasing the sale of the item.

Preferably the data analysis includes a purchaser attribute analysis for each item and an item data analysis for each purchaser attribute.

In the present invention a purchaser attribute analysis can be performed for each item and used to extract for the item an attribute corresponding to a large number of purchasers or that corresponding to a small number of purchasers. Furthermore, an item data analysis can also be provided for each purchaser attribute and used to extract a good seller for the attribute. Thus the data analysis can more appropriately be provided and used for example to increase the sale of the item.

Furthermore the present invention in another aspect provides a customer information management method including the steps of: obtaining image information of a customer having purchased an item; determining a first attribute of the customer from the image information obtained; obtaining data of the item purchased by the customer; and recording the data of the item obtained and the first attribute of the customer determined, the data and the first attribute being correlated with each other.

In the present invention image information of a customer purchasing an item is used to determine an attribute of the customer. This can alleviate an operation entering information of the attribute of the customer. Furthermore the attribute can be determined free of variation as it is determined by referring to a uniform reference provided by image information. The attribute of the customer thus determined and data of an item purchased by the customer are correlated with each other and thus recorded.

Since the entry operation can be alleviated and the attribute of the customer can also be determined free of variation, the customer information management method can create an accurate database.

Preferably the step of recording includes recording a second attribute of the customer, the second attribute being correlated with the item purchased, the second attribute being determined through a human perception.

In the present invention, in the step of recording, a second attribute determined through a human perception is also recorded, correlated with the item. Thus, an attribute which can be determined through the human perception without a significant variation, such as whether the customer comes alone/in couples/together with his or her family, and which can hardly be determined automatically by processing an image, is determined through the human perception and the resultant decision is recorded. Thus the attribute can appropriately and thus more accurately be determined and thus recorded.

Preferably the customer information management method further includes the step of providing a data analysis based on the data of the item recorded and the attribute of the customer.

In the present invention the step of providing a data analysis can provide an appropriate data analysis based on data of an item and an attribute of a customer for example to increase the sale of the item.

Preferably the data analysis includes a purchaser attribute analysis for each item and an item data analysis for each purchaser attribute.

In the present invention a purchaser attribute analysis can be performed for each item and used to extract for the item an attribute corresponding to a large number of purchasers or that corresponding to a small number of purchasers. Furthermore, an item data analysis can also be provided for each purchaser attribute and used to extract a good seller for the attribute. Thus the data analysis can more appropriately be provided and used for example to increase the sale of the item.

The present invention in still another aspect provides a computer-readable recording medium having a customer information management program recorded therein and causing a computer to execute the steps of: obtaining image information of a customer having purchased an item; determining a first attribute of the customer from the image information obtained; obtaining data of the item purchased by the customer; and recording the data of the item obtained and the first attribute of the customer determined, the data and the first attribute being correlated with each other.

In the present invention there can be provided a computer-readable recording medium having a customer management program recorded therein and causing a computer to execute a customer information management method alleviating an entry operation and also allowing a customer attribute to be determined free of variation to create an accurate database.

Furthermore the present invention in still another aspect provides a customer information management system including: a first image acquisition block obtaining image information of a customer entering a shop; a second image acquisition block obtaining image information of a customer having purchased an item; a first extraction block referring to the image information obtained by the first image acquisition block and the image information obtained by the second image acquisition block, to extract image information obtained exclusively by the first image acquisition block; an attribute acquisition block obtaining an attribute of a customer corresponding to the image information extracted; and a recording block recording, for the customer corresponding to the image information extracted, information indicative of a non-purchaser and the attribute obtained, the information and the attribute being correlated with each other.

In the present invention, a first image acquisition block obtains image information and a second image acquisition block obtains image information and the information thus obtained is referred to to extract image information obtained exclusively by the first image acquisition block. Thus, image information of a customer leaving a shop without purchasing an item, is extracted. The customer corresponding to the extracted image information is correlated with information indicative of a non-purchaser and an attribute and thus recorded.

Thus the customer information management system can create a database of information on non-purchasers to develop a marketing strategy for the non-purchasers.

Preferably in the customer information management system the attribute acquisition block includes a first determination block determining from the image information extracted the attribute of the customer corresponding to the image information extracted.

In the present invention, extracted image information is used to determine an attribute of a customer (a non-purchaser). The customer's attribute is automatically determined to alleviate an attribute entry operation imposed for example on a clerk. Furthermore the image information serves as a uniform reference for determining the attribute so as to determine the same free of variation.

Preferably the customer information management system further includes: an item data acquisition block obtaining data of the item purchased by the customer corresponding to the image information obtained by the second image acquisition block; and a second determination block determining an attribute of the customer from the image information obtained by the second image acquisition block, wherein for the customer corresponding to the image information obtained by the second image acquisition block, the recording block further records information indicative of a purchaser, the data of the item obtained, and the attribute determined by the second acquisition block, the information, the data and the attribute being correlated with each other.

In the present invention, data of an item purchased by a customer and an attribute of the customer determined from image information, together with information indicating that the customer is a purchaser, are correlated with the customer and recorded. Thus, in addition to information indicative of a non-purchaser, information indicative of a purchaser is also provided appropriately in the form of a database.

Preferably the customer information management system further includes an analysis block providing a data analysis based on data recorded in the recording block.

Preferably the data analysis includes an item data analysis for each purchaser attribute and an attribute analysis for each of a purchaser and a non-purchaser.

In the present invention, purchaser/non-purchaser information, an attribute, data of an item, and other data that are recorded in the recording block, are used to provide an item data analysis for each purchaser attribute, an attribute analysis for each of a purchaser and a non-purchaser, and other similar data analyses. The user can use a result of the data analysis to develop an appropriate marketing strategy.

Preferably, if the recording block records data received from a plurality of shops, the analysis block uses the data of the plurality of shops recorded in the recording block to provide a data analysis to develop a strategy for each shop.

In the present invention, if the recording block records data received from a plurality of shops, the data of the plurality of shops are used to perform a data analysis required for example for a marketing strategy for each shop. For example, if non-purchasers of a target shop have the same attribute(s) as purchases of a different shop, offering in the target shop an item bought by the purchasers in the different shop can be considered as a marketing strategy.

The present invention in another aspect provides a customer information management method including the steps of: obtaining image information of a customer entering a shop; obtaining image information of a customer having purchased an item; comparing the image information obtained in the step of obtaining the image information of the customer entering the shop and the image information obtained in the step of obtaining the image information of the customer having purchased the item, and extracting image information obtained exclusively in the step of obtaining the image information of the customer entering the shop; obtaining an attribute of a customer corresponding to the image information extracted; and for the customer corresponding the image information extracted, recording information indicative of a non-purchaser and the attribute obtained, the information and the attribute being correlated with each other.

In the present invention, image information is obtained in the step of obtaining image information of a customer entering a shop and image information is also obtained in the step of obtaining image information of a customer having purchased an item and the image information thus obtained is referred to to extract image information obtained exclusively in the step of obtaining image information of a customer entering a shop. Thus, image information of a customer leaving a shop without purchasing an item, is extracted. The customer corresponding to the extracted image information is correlated with information indicative of a non-purchaser and an attribute and thus recorded.

Thus the customer information management method can create a database of information on non-purchasers to develop a marketing strategy for the non-purchasers.

Preferably in the customer information management method the step of obtaining an attribute includes determining from the information extracted the attribute of the customer corresponding to the image information extracted.

In the present invention, extracted image information is used to determine an attribute of a customer (a non-purchaser). The customer's attribute is automatically determined to alleviate an attribute entry operation imposed for example on a clerk. Furthermore the image information serves as a uniform reference for determining the attribute so as to determine the same free of variation.

Preferably the customer information management method further includes the steps of: obtaining data of the item purchased by the customer corresponding to the image information obtained in the step of obtaining the image information of the customer having purchased the item; and determining an attribute of the customer from the information obtained in the step of obtaining the image information of the customer having purchased the item, wherein for the customer corresponding to the image information obtained in the step of obtaining the image information of the customer having purchased the item, the step of recording records information indicative of a purchaser, the data of the item obtained, and the attribute determined in the step of obtaining the image information of the customer having purchased the item, the information, the data and the attribute being correlated with each other.

In the present invention, data of an item purchased by a customer and an attribute of the customer determined from image information, together with information indicating that the customer is a purchaser, are correlated with the customer and recorded. Thus, in addition to information indicative of a non-purchaser, information indicative of a purchaser is also provided appropriately in the form of a database.

Preferably the customer information management method further includes the step of providing a data analysis based on data recorded in the step of recording.

Preferably the data analysis includes an item data analysis for each purchaser attribute and an attribute analysis for each of a purchaser and a non-purchaser.

In the present invention, purchaser/non-purchaser information, an attribute, data of an item, and other data that are recorded in the recording block, are used to provide an item data analysis for each purchaser attribute, an attribute analysis for each of a purchaser and a non-purchaser, and other similar data analyses. The user can use a result of the data analysis to develop an appropriate marketing strategy.

Preferably if data received from a plurality of shops are recorded in the step of recording, the step of providing a data analysis uses the data of the plurality of shops recorded in the step of recording, to provide the data analysis to develop a strategy for each shop.

In the present invention, if data received from a plurality of shops are recorded in the step of recording, the data of the plurality of shops are used to perform a data analysis required for example for a marketing strategy for each shop. For example, if non-purchasers of a target shop have the same attribute(s) as purchases of a different shop, offering in the target shop an item bought by the purchasers in the different shop can be considered as a marketing strategy.

The present invention in still another aspect provides a computer-readable recording medium having a customer information management program recorded therein and causing a computer to execute the steps of: obtaining image information of a customer entering a shop; obtaining image information of a customer having purchased an item; comparing the image information obtained in the step of obtaining the image information of the customer entering the shop and the image information obtained in the step of obtaining the image information of the customer having purchased the item, and extracting image information obtained exclusively in the step of obtaining the image information of the customer entering the shop; obtaining an attribute of a customer corresponding to the image information extracted; and for the customer corresponding to the image information extracted, recording information indicative of a non-purchaser and the attribute obtained, the information and the attribute being correlated with each other.

In the present invention, there can be provided the computer-readable recording medium having recorded therein a customer information management program capable of creating a database of information on non-purchasers to develop a marketing strategy for the non-purchasers.

Furthermore the present invention in still another aspect provides a customer information management system including: a recording block recording image information of a customer of a shop and a frequency of the customer's appearance in the shop, the image information and the frequency being correlated with each other; an acquisition block obtaining image information of a customer entering the shop; a comparison block comparing the image information recorded in the recording block and the image information obtained with each other to determine whether the image information match each other; an increment block incrementing by one a frequency of appearance in the shop recorded and corresponding to the image information recorded in the recording block and matching the image information obtained; and an addition block adding to the recording block the image information obtained, if a comparison made by the comparison block reveals that the recording block does not have image information matching the image information obtained.

In the present invention, if the recording block has image information matching image information of a customer in a shop, a decision is made that the image information both correspond to a single person and the information of the customer's frequency of appearance in the shop is updated by incrementing by one the customer's appearance frequency recorded correspondingly in the recording block. If the recording block does not have image information matching image information of a customer in the shop, a decision is made that the customer is a new customer, and the image information of the customer, the information of the customer's frequency of appearance in the shop (of one) and other similar information are recorded in the recording block. Thus the recording block appropriately accumulates information on how frequently customers come to the shop.

Thus the customer information management system can create a database of information on customers' frequencies of appearance in the shop to develop an appropriate marketing strategy based on the frequencies.

Preferably the customer information management system further includes a determination block referring to the frequency recorded in the recording block, to determine whether the customer is a regular customer or a new customer, the determination block determining that the customer is a regular customer if the frequency has at least a predetermined value for a predetermined period of time, the determining block determining that the customer is a new customer if the frequency is less than the predetermined value for the predetermined period of time.

In the present invention, if a customer's frequency of appearance in a shop for a predetermined temporal period is no less than a predetermined value then a decision is made that the customer is a regular customer and if the frequency is less than the predetermined value then a decision is made that the customer is a new customer. Thus a customer's frequency of appearance in the shop can be referred to to determine whether the customer is a regular customer or a new customer.

Preferably the customer information management system further includes an extraction block extracting feature data from image data of a customer image-sensed, wherein the image information obtained by the acquisition block is the feature data extracted by the extraction block.

In the present invention, feature data is extracted from image data of a customer image-sensed and it is recorded in the recording block as information of the customer. The feature data is smaller in data capacity than the entire image data and thus advantageously occupy a smaller memory capacity when it is recorded in the recording block. Furthermore, the comparison block can make a comparison more readily as it compares feature data.

Preferably the customer information management system further includes an item data acquisition block obtaining data of an item purchased by a customer, wherein the recording block further records the data of the item obtained, the data being correlated with the image information of the customer and the frequency.

In the present invention, data of an item purchased in a shop by a customer is also recorded as one of information of the customer. Thus the recorded data can be used for example to analyze a relationship between the customer's frequency of appearance in the shop and the data of the item.

Preferably the customer information management system further includes an analysis block providing a data analysis based on data recorded in the recording block.

Preferably the data analysis includes an item data analysis for each of regular and new customers.

In the present invention, data of a customer that are recorded in the recording block, such as the customer's image information, frequency of appearance in the shop, data of items purchased, and the like, can be used to provide a desired data analysis, such as an item data analysis for regular customers and that for new customers separately.

Preferably, if the recording block records data received from a plurality of shops, the analysis block uses the data of the plurality of shops in the recording block to provide the data analysis to develop a strategy for each shop.

In the present invention, if the recording block records data from a plurality of shops, the data of the plurality of shops are used to provide a data analysis required for example for a marketing strategy for each shop. For example, with reference to the frequency of appearance in the shop, the frequency of purchase, the preference in purchasing items, and the like, each for regular customers and new customers separately, preferences of customers of other shops can be based on to develop a marketing strategy, such as changing or adjusting items to be offered.

The present invention in another aspect provides a customer information management method including the steps of: recording image information of a customer of a shop and a frequency of the customer's appearance in the shop, the image information and the frequency being correlated with each other; obtaining image information of a customer entering the shop; comparing the image information recorded in the step of recording and the image information obtained with each other to determine whether the image information match each other; incrementing by one a frequency of appearance in the shop recorded and corresponding to the image information recorded in the step of recording and found to match the image information obtained; and adding to the recording block the image information obtained, if a comparison made in the step of comparing reveals that the image information recorded in the step of recording do not include image information matching the image information obtained.

In the present invention, if the recording block has image information matching image information of a customer in a shop, a decision is made that the image information both correspond to a single person and the information of the customer's frequency of appearance in the shop is updated by incrementing by one the customer's appearance frequency recorded correspondingly in the recording block. If the recording block does not have image information matching image information of a customer in the shop, a decision is made that the customer is a new customer, and the image information of the customer, the information of the customer's frequency of appearance in the shop (of one) and other similar information are recorded in the recording block. Thus the recording block appropriately accumulates information on how frequently customers come to the shop.

Thus the customer information management method can create a database of information on customers' frequencies of appearance in the shop to develop an appropriate marketing strategy based on the frequencies.

Preferably the customer information management method further includes the step of referring to the frequency recorded in the recording block, to determine whether the customer is a regular customer or a new customer, wherein in the step of determining, the customer is determined as a regular customer if the frequency has at least a predetermined value for a predetermined period of time, and the customer is determined as a new customer if the frequency is less than the predetermined value for the predetermined period of time.

In the present invention, if a customer's frequency of appearance in a shop for a predetermined temporal period is no less than a predetermined value then a decision is made that the customer is a regular customer and if the frequency is less than the predetermined value then a decision is made that the customer is a new customer. Thus a customer's frequency of appearance in the shop can be referred to to determine whether the customer is a regular customer or a new customer.

Preferably the customer information management method further includes the step of extracting feature data from image data of a customer image-sensed, wherein the image information obtained in the step of obtaining is the feature data extracted in the step of extracting.

In the present invention, feature data is extracted from image data of a customer image-sensed and it is recorded in the recording block as information of the customer. The feature data is smaller in data capacity than the entire image data and thus advantageously occupy a smaller memory capacity when it is recorded in the recording block. Furthermore, in the step of comparing, a comparison can be made more readily as feature data are compared.

Preferably the customer information management method further includes the step of obtaining data of an item purchased by a customer, wherein the step of recording further records the data of the item obtained, the data being correlated with the image information of the customer and the frequency.

In the present invention, data of an item purchased in a shop by a customer is also recorded as one of information of the customer. Thus the recorded data can be used for example to analyze a relationship between the customer's frequency of appearance in the shop and the data of the item.

Preferably the customer information management method further includes the step of providing a data analysis based on data recorded in the recording block.

Preferably the data analysis includes an item data analysis for each of regular and new customers.

In the present invention, data of a customer that are recorded in the recording block, such as the customer's image information, frequency of appearance in the shop, data of items purchased, and the like, can be used to provide a desired data analysis, such as an item data analysis for regular customers and that for new customers separately.

Preferably if the recording block records data received from a plurality of shops the step of providing a data analysis uses the data of the plurality of shops in the recording block to provide the data analysis to develop a strategy for each shop.

In the present invention, if the recording block records data from a plurality of shops, the data of the plurality of shops are used to provide a data analysis required for example for a marketing strategy for each shop. For example, with reference to the frequency of appearance in the shop, the frequency of purchase, the preference in purchasing items, and the like, each for regular customers and new customers separately, preferences of customers of other shops can be based on to develop a marketing strategy, such as changing or adjusting items to be offered.

The present invention in still another aspect provides a computer-readable recording medium having a customer information management program recorded therein and causing a computer to execute the steps of: recording image information of a customer of a shop and a frequency of the customer's appearance in the shop, the image information and the frequency being correlated with each other; obtaining image information of a customer entering the shop; comparing the image information recorded in the step of recording and the image information obtained with each other to determine whether the image information match each other; incrementing by one a frequency of appearance in the shop recorded and corresponding to the image information recorded in the step of recording and found to match the image information obtained; and adding to the recording block the image information obtained, if a comparison made in the step of comparing reveals that the image information recorded in the step of recording do not include image information matching the image information obtained.

Thus there can be provided a computer-readable recording medium having recorded therein a customer information management program capable of creating a database of information of customers' frequencies of appearance in a shop to develop an appropriate marketing strategy based on the frequencies.

The present invention in still another aspect provides a customer information management system including: a camera image-sensing a customer in a shop to generate an image signal of the customer; a first processor receiving the image signal to determine an attribute of the customer; a first input unit receiving information of an item purchased by the customer; and a first recording block recording the information of the item received and the attribute of the customer determined, the information and the attribute being correlated with each other.

In the present invention a camera is used to image-sense a customer in a shop to generate an image signal of the customer which is in turn used to determine an attribute of the customer. This can alleviate an operation entering information of the attribute of the customer. Furthermore the attribute can be determined free of variation as it is determined by referring to a uniform reference provided by image information. The attribute of the customer thus determined and data of an item purchased by the customer are correlated with each other and thus recorded.

Since the entry operation can be alleviated and the attribute of the customer can also be determined free of variation, the customer information management system can create an accurate database.

Preferably the camera positioned and timed, as predetermined, to image-sense a customer. Thus an image signal of the customer can appropriately be generated.

Preferably the camera is arranged to image-sense the face of a customer. Thus an attribute of the customer can be determined more precisely.

Preferably the attribute of the customer includes sex or age. Recording sex or age as an attribute allows an item marketing strategy to be developed with sex or age taken into account.

Preferably information of an item includes the name of the item. Recording the name of an item as information allows a target to be made clear and an item marketing strategy to be developed more precisely.

Preferably, the camera, the first processor, the first input unit and the first recording block are installed inside the shop. Thus an image signal can be generated with precision and improved convenience can be achieved.

Preferably the customer information management system further includes a second input unit receiving an attribute of the customer, wherein the first recording block further records an attribute different in type from the attribute of the customer received by the second input unit, the attribute different in type being correlated with the information of the item. Thus, more detailed information can be used to provide a data analysis and the like.

Preferably the customer information management system further includes a second processor providing a data analysis based on the information of the item recorded and the attribute of the customer, wherein the camera, the first processor, the first input unit and the first recording block are arranged inside the shop as an internal device and the second processor is arranged outside the shop and capable of communicating with the internal device. Since the second processor providing a data analysis is installed outside the shop, the equipment inside the shop can be minimized.

Preferably, the camera includes a first camera image-sensing a customer having entered the shop and a second camera image-sensing a customer having purchased an item, the first processor receives the image signal generated by the first camera and an image signal generated by the second camera, to determine for the image signal generated exclusively by the first camera the attribute of the customer having entered the shop, and the first recording block further records information indicating that the customer is a non-purchaser, the information being added to the attribute of the customer determined.

In the present invention, an attribute is determined for an image signal of a customer having left the shop without purchasing an item and both are correlated with each other and thus recorded in the first recording block. Thus the customer information management system can create a database of information on non-purchaser to develop a marketing strategy for the non-purchasers.

Preferably the first camera is installed in the vicinity of an entrance of a shop and the second camera is installed in the vicinity of a cash desk of the shop. The first camera thus installed can appropriately image-sense a customer entering the shop and the second camera thus installed can appropriately image-sense a customer purchasing an item.

Preferably, the camera includes a first camera image-sensing a customer having entered the shop and a second camera image-sensing a customer having purchased an item, the first processor receives the image signal generated by the first camera and an image signal generated by the second camera, to determine the attribute of the customer for the image signal generated by both of the first and second cameras, and the first recording block further records information indicating that the customer is a purchaser, the information being added to the attribute of the customer determined.

In the present invention an attribute is determined for an image signal of a customer having purchased an item in a shop and the first recording block records information indicative of a purchaser, correlated with the image information of the customer. Thus a database of information on purchasers can be created.

Preferably the customer information management system further includes: a second recording block recording an image signal representative of a customer of a shop and a frequency of the customer's appearance in the shop, the image signal representative of the customer and the frequency being correlated with each other; and a third processor incrementing by one the frequency correlated with the image signal recorded in the second recording block and found to match the image signal generated by the camera.

In the present invention, an image signal representative of a customer of a shop and the customer's frequency of appearance in the shop are correlated with each other and thus recorded. When the customer has entered the shop the customer's frequency of appearance in the shop increments by one. Thus the second recording block appropriately accumulates information of the frequency.

Preferably the third processor additionally records in the second recording block the image signal of the customer generated by the camera if the image signal of the customer generated by the camera is not present in the second recording block.

In the present invention, a new customer who is not found in the second recording block is additionally recorded and the customer's frequency of appearance in the shop would be counted.

The foregoing and other objects, features, aspects and advantages of the present invention will become more apparent from the following detailed description of the present invention when taken in conjunction with the accompanying drawings.

### BRIEF DESCRIPTION OF THE DRAWINGS

In the drawings,

FIG. 1 is a block diagram showing a general configuration of a customer information analysis system employing the present invention to analyze information;

FIG. 2 is a flow chart of a process provided to record in a visitor database necessary information of a customer coming to a shop;

FIG. 3 is a flow chart of a process provided to record in a customer database an attribute of a customer when the customer comes to a cash desk to purchase an item;

FIGS. 4A and 4B show an example of data transmitted to an information analysis center when a customer comes to a cash desk and purchases an item;

FIG. 5 is a flow chart of a process provided to record in a customer DB an attribute of a customer leaving a shop;

FIGS. 6A and 6B show an example of data transmitted to an information analysis center when a customer leaves a shop;

FIG. 7 shows an example of a list produced by an information analysis center, including purchaser/non-purchaser information, purchased items and the like for attributes of customers;

FIG. 8 shows an example of a list produced by the information analysis center, including customer attributes, time of purchase, and the like for each item;

FIG. 9 is a flow chart of a first analysis procedure focusing on a group of non-purchasers to analyze which item is recommendable to be additionally offered in each shop;

FIG. 10 is a flow chart of a second analysis procedure focusing on a group of non-purchasers to analyze which item is recommendable to be additionally offered in each shop;

FIG. 11 is a flow chart representing a procedure of analyzing which item is no longer recommendable to be offered in each shop;

FIG. 12 is a flow chart of a first analysis procedure focusing on a regular customer/new customer information to analyze which item is recommendable to be additionally offered in each shop;

FIG. 13 is a flow chart of a second analysis procedure focusing on a regular customer/new customer information to analyze which item is recommendable to be additionally offered in each shop; and

FIG. 14 is a flow chart of a third analysis procedure focusing on a regular customer/new customer information to analyze which item is recommendable to be additionally offered in each shop.

### DESCRIPTION OF THE PREFERRED EMBODIMENTS

An embodiment of the present invention will now be described with reference to the drawings.

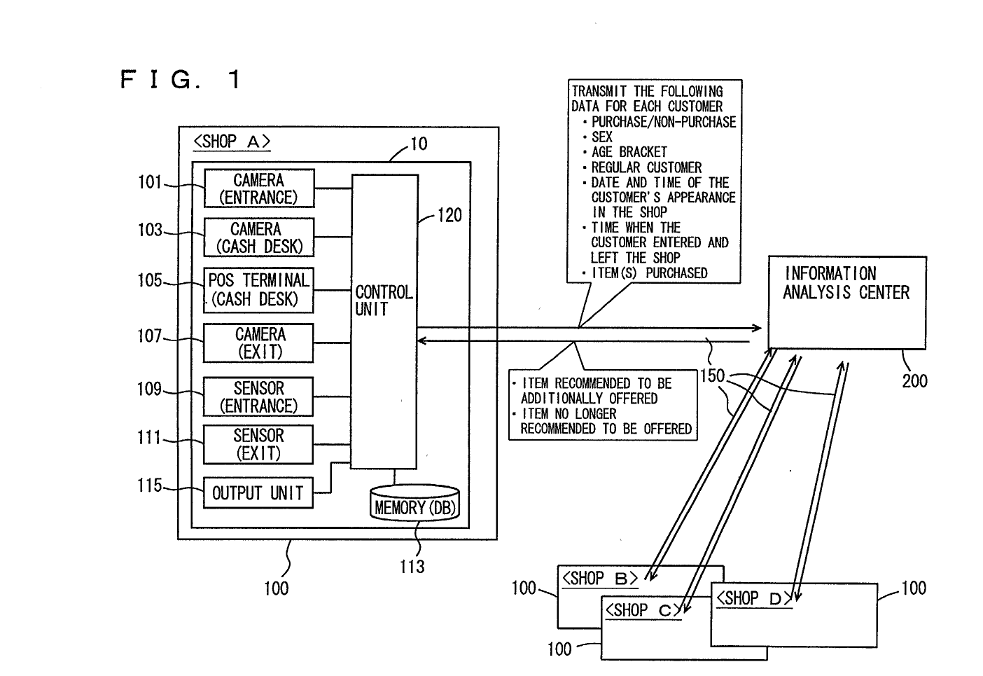

With reference to FIG. 1, a customer information analysis system is configured by a plurality of shops 100 connected to a network 150 such as the Internet to communicate with an information analysis center 200 providing an analysis based on information received from the plurality of shops 100.

Each shop 100 transmits data such as an attribute of a customer to information analysis center 200 via network 150. Information analysis center 200 transmits to each shop 100 a result of an analysis based on the data of a customer that is received.

Each shop 100 has a customer information management system 10. Customer information management system 10 includes cameras 101, 103 and 107 installed in each shop at an entrance, a cash desk and an exit, respectively, sensors 109 and 111 installed at the entrance and the exit, respectively, a point of sales (POS) terminal 105 arranged at the cash desk, a memory (DB) 113 storing data of items, attributes of purchasers and the like, an output unit 115 such as a display, a printer and the like, and a control unit 120 controlling these components.

Sensors 109 and 111 sense a customer entering the shop through the entrance and a customer leaving the shop through the exit, respectively. When sensors 109 and 111 sense a customer, cameras 101 and 107 respectively corresponding thereto image-sense the sensed, target customer. The sensors may detect whether the entrance door and the exit door are opened/closed, rather than the exact customer. Camera 105 arranged at the cash desk image-senses at a predetermined timing a customer who comes to the cash desk to purchase an item.

Memory 113 includes a visitor database (not shown) temporarily storing data of people having entered the shop and a customer database (not shown) storing attributes of customers. Output unit 115 for example displays in the form of a list a result of an analysis received from information analysis center 200.

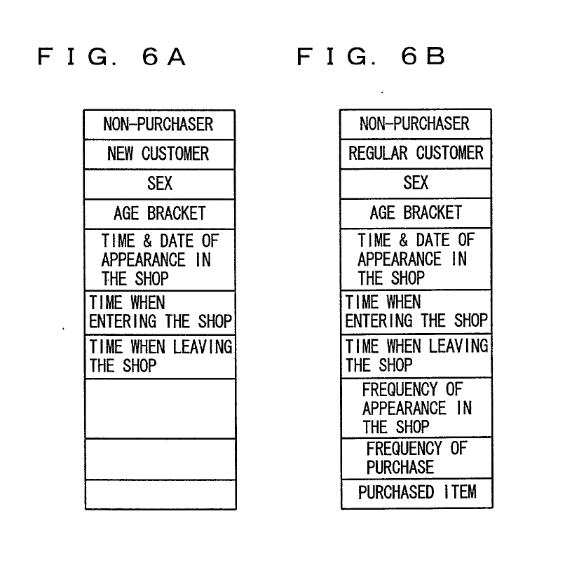

Reference will now be made to FIGS. 6A and 6B to describe the flow of a processing provided by control unit 120 of the customer information management system provided in each shop 100.

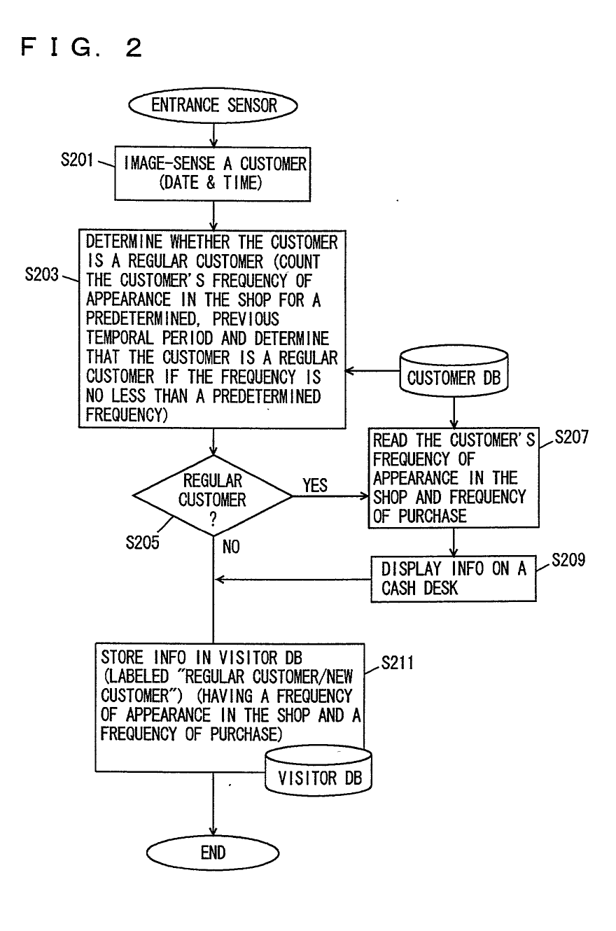

FIG. 2 is a flow chart of a process provided to record in the visitor database (hereinafter referred to as “the visitor DB”) necessary information of a customer coming to the shop. With reference to the figure, if entrance sensor 109 senses a customer entering the shop then at step S201 camera 101 installed at the entrance starts image-sensing the customer. Furthermore, the date and time at which the customer has been image-sensed is also obtained as information.

At step S203 the image of the customer is compared with images stored in the customer database (hereinafter referred to as “the customer DB”) and the control determines whether the target customer is a regular customer. More specifically, the decision is made as follows: the customer DB stores how frequently each customer came to the shop in the past for a predetermined period of time. The customer's frequency of appearance in the shop increments whenever the customer comes to the shop. If the customer comes to the shop more frequently than a predetermined frequency then the customer is determined as a regular customer and if not then the customer is determined as a new customer. Note that herein images are matched through a well known image matching process such as disclosed in U.S. Pat. No. 5,740,274, which is hereby incorporated by reference.

If at step S205 the customer is determined as a regular customer, the control moves on to step S207, at which is read from the customer DB the customer's frequency of appearance in the shop, i.e., the information on how many days have passed since the customer's last appearance in the shop, and how frequently the customer purchases items. Then at step S209 the regular-customer information is displayed on the cash desk for example to allow a clerk to provide improved services and ensure security. Then the control moves on to step S211.

If at step S205 the control determines that the customer is not a regular customer or the customer is a new customer then the control moves on directly to step S211.

At step S211 the customer is labeled “regular customer” or “new customer” and the information of the appearance and purchase frequencies that have been previously read from the customer DB is temporarily stored in the visitor DB together with an image of the customer's face.

Thus a shopper entering a shop through an entrance is image-sensed to temporarily store in the visitor DB the shopper's image information, regular customer/new customer information, frequency of appearance in the shop and frequency of purchase.

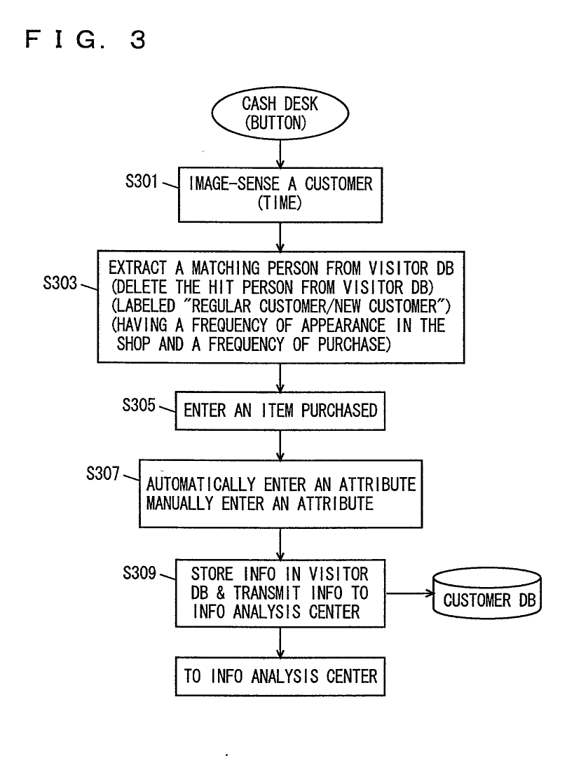

FIG. 3 is a flow chart of a process provided to record in the customer DB an attribute of a customer coming to a cash desk to purchase an item. With reference to the figure, a customer desiring to purchase an item is taken care of at a cash desk by a clerk, who presses a predetermined button and responsibly at step S301 cash desk camera 103 start image-sensing the customer. Furthermore, the time at which the customer has been image-sensed is also obtained as information. Note that while in the above description the camera starts its operation in response to a clerk pressing the button, it may alternatively start its operation according to a result of a detection provided by a sensor installed at the cash desk.

Then at step S303 a person matching an image obtained by cash desk camera 103 is extracted from images stored in the visitor DB. Furthermore, data on the extracted person, such as whether the person is a regular customer or a new customer, how frequently the person comes to the shop, and how frequently the person purchases items, are also read from the visitor DB. Then the data of the person is deleted from the visitor DB together with the image information.

Then at step S305 data of an item purchased by the customer is input through POS terminal 105 and at step S307 an attribute of the customer is input. The attribute input may include sex, age bracket, whether the customer comes alone/in couples/together with his or her family, and the like.

Note that customer attributes are herein grouped into those automatically entered and those manually entered. More specifically, an image obtained is processed to determine a sex and an age bracket, which are entered automatically, whereas a clerk determines whether a customer has come alone/in couples/together with the customer's family, which information is entered manually. Sex, age bracket and other similar attributes that can readily be determined by processing an image, can be determined by processing the image according to a predetermined reference to provide a variation-free decision. Furthermore, automatically entering the decision also alleviates an entry operation imposed on the clerk.

Note that an attribute may be determined for example by initially referring to image data of a customer to determine a height and then determining an age bracket from the determined height or by referring to image data to determine the customer's appearance, such as whether the customer is wearing a skirt, whether the customer is wearing makeup, whether the customer has long hair, and the like, and then determining the customer's sex from the decisions.

In contrast, it is difficult to determine by processing an image whether a customer comes alone/in couples/together with his or her family. However, such would be determined through human perception without significant variation and is thus entered manually, although alternatively it may be determined by processing an image.

When necessary data are obtained in steps S301 through S307, as described above, then at step S309 data of the customer including the data obtained as above are correlated with the customer and an image data of the customer and thus stored in the customer DB. Simultaneously, the data of the customer is also transmitted to information analysis center 200.

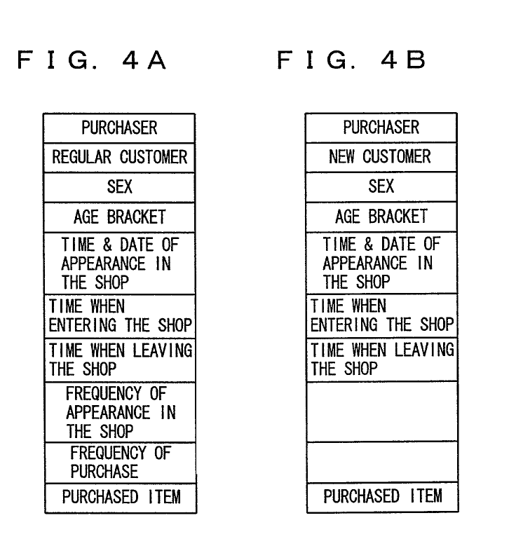

FIGS. 4A and 4B shows an example of data transmitted to information analysis center 200 when a customer comes to a cash desk and has purchased an item. As shown in FIGS. 4A and 4B, information analysis center 200 receives information associated with a label “purchaser”. The information for example includes regular customer/new customer information, sex, age bracket, the date of the customer's appearance in the shop, the time at which the customer entered the shop, the time at which the customer left the shop, how frequently the customer comes to the shop (the customer's frequency of appearance in the shop), how frequently the customer purchases items(the customer's frequency of purchase), and the item(s) purchased by the customer. If the customer is a new customer, the data of appearance and purchase frequencies are not transmitted, as shown in FIG. 4B. Information analysis center 200 counts data transmitted for each customer and provides an analysis as required, as will be described in detail hereinafter.

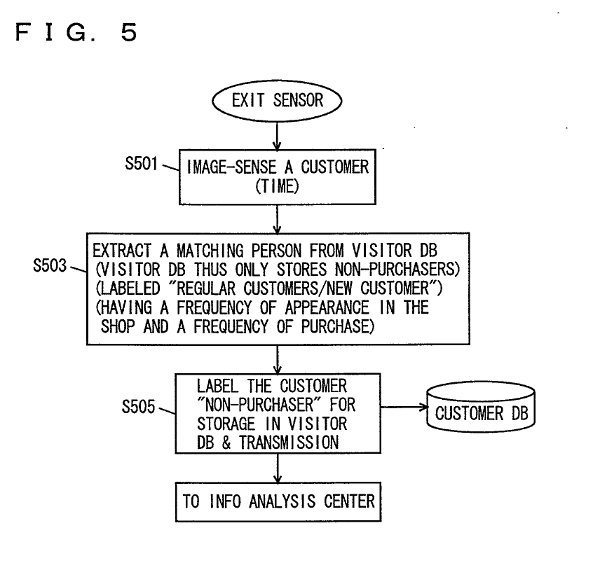

FIG. 5 is a flow chart of a process provided to record in the customer DB an attribute of a customer leaving a shop. With reference to the figure, when exit sensor 111 senses a customer leaving the shop, at step S501 exit camera 107 starts image-sensing the customer. Furthermore, the time at which the customer is image-sensed is also obtained as information.

At step S503, an image of a person stored in the visitor DB that matches the image of the customer, is extracted from the visitor DB, when information on the extracted person, such as whether the customer is a regular customer or a new customer, the customer's frequency of appearance in the shop and the customer's frequency of purchase, are read. If the customer is a new customer then the obtained image is processed to determine and automatically enter the customer's sex, age bracket and other similar attributes.

Note that as has been described with reference to FIG. 3 a person coming to the cash desk and having purchased an item is extracted from the visitor DB all of the data of the person are deleted therefrom. Thus, the data remaining therein are data of people who have not purchased any item and the person extracted is also a person who is leaving the shop without purchasing any item.

Thus at step S505 the target person's image is labeled “non-purchaser” and stored in the customer DB together with other necessary data of the customer. Simultaneously, the data of the customer is also transmitted to information analysis center 200.

FIGS. 6A and 6B shows an example of data transmitted to information analysis center 200 when a customer leaves a shop. With reference to FIGS. 6A and 6B, information analysis center 200 receives necessary data for each customer, with a label “non-purchaser” attached thereto. If a customer is a new customer, the data is transmitted, associated with information including the customer's sex and other similar attributes, the date of his/her appearance in the shop, and the like, as shown in FIG. 6A, and if the customer is a regular customer, then, as shown in FIG. 6B, known data are transmitted such as the customer's frequency of appearance in the shop, the item(s) previously purchased by the customer, and the like..

When information analysis center 200 has received data for example of an attribute of each customer, an item purchased by the customer, and the like, as shown in FIGS. 4A and 4B and 6A and 6B, information analysis center 200 counts data, as described hereinafter.

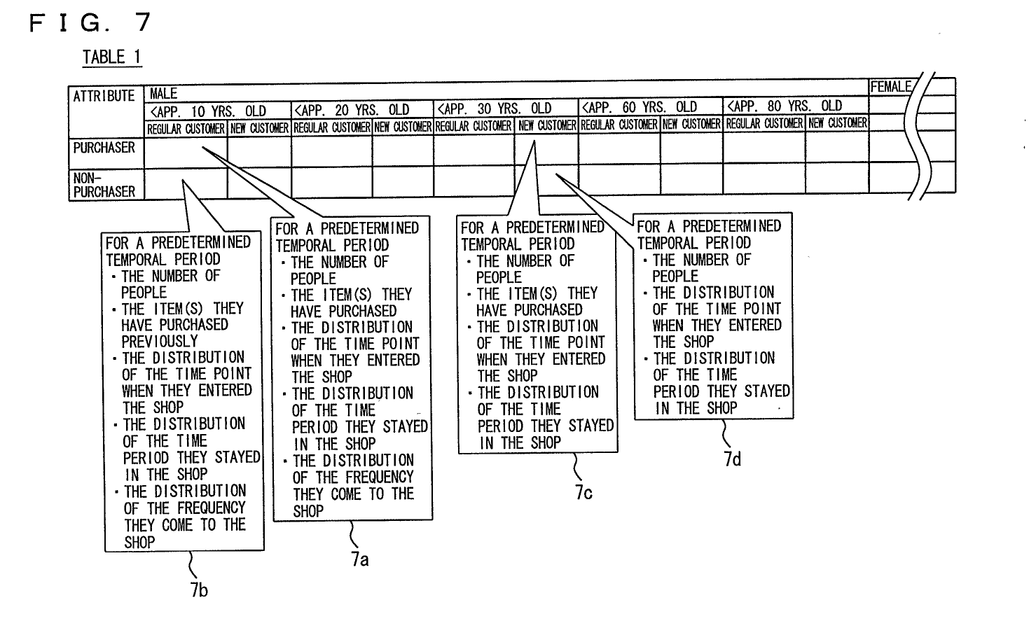

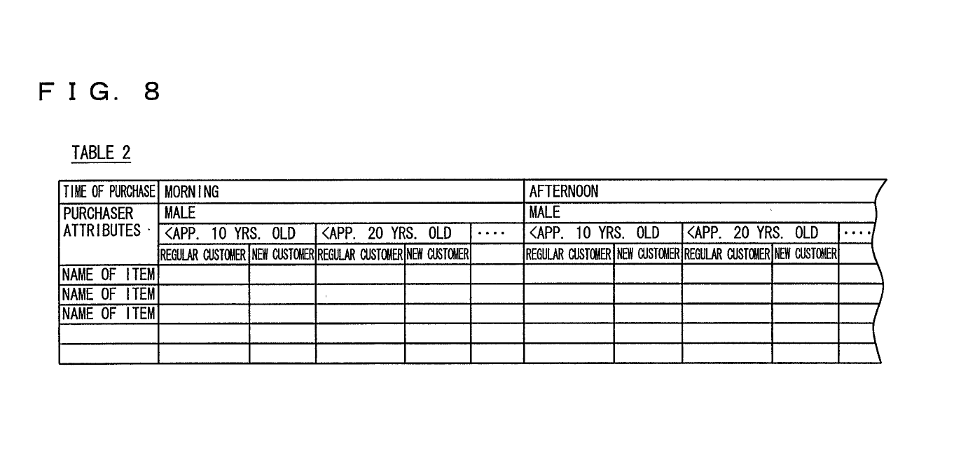

FIGS. 7 and 8 show a list produced by information analysis center 200 counting the data. Note that such a list formed by counting data can also be formed not only by information analysis center 200 but also from the customer DB of each shop 100.

FIG. 7 shows an example of a list (a Table 1) produced by information analysis center 200, indicating purchaser/non-purchaser information, purchased items and the like for customer attributes. Itemized herein are customer attributes of sex and age bracket and in addition thereto regular customer/new customer information, for purchasers and non-purchases, separately, as information, as predetermined.

For example in a column of “regular customer” and “purchaser” are indicated how many such people have come to the shop, which item(s) they have purchased, when in a day they entered the shop, how long they stayed in the shop, how frequently they come to the shop, and the like, as labeled 7a, all for a predetermined period of time. In a column of “regular customer” and “non-purchaser” are indicated how many such people have come to the shop, which item(s) they previously purchased, when in a day they came to the shop, how long they stayed in the shop, how frequently they come to the shop, as labeled 7b, all for a predetermined period of time. In a column of “new customer” and “purchaser”n are indicated how many such people have come to the shop, which item(s) they have purchased, when in a day they entered the shop, how long they stayed in the shop, and the like, as labeled 7c, and in a column of “new customer” and “non-purchaser” are indicated how many such people have come to the shop, when in a day they entered the shop, how long they stayed in the shop, and the like, as labeled 7d.

The list thus representing the information is in turn transmitted from information analysis center 200 to each shop 100. The list is received by a user, i.e., a shop manager and from the list the user can obtain necessary information.

Note that if a data analysis is provided as described hereinafter, a list having the same items as Table 1 shown in FIG. 7 is used, although the data indicated in each column is different. More specifically, each column does not indicate such information as labeled 7a-7d but simply the number of customers of interest that is required for analysis (the number of people counted for a predetermined period of time).

FIG. 8 shows an example of a list (a Table 2) created by information analysis center 200, including which attribute(s) a customer purchasing an item has, when the customer purchased the item, and the like. With reference to the figure, for each item a value is indicated in a column of “time of purchase” and “purchaser attributes” of interest. Thus Table 2 can indicate an attribute of customers having purchased a good seller and when they purchased that good seller. Furthermore the table can also indicate the name of a good seller for each attribute. As such, a correlation can be established between the good seller and the attribute of customers having purchased the good seller and it can thus be used for example to increase the sale of the item.

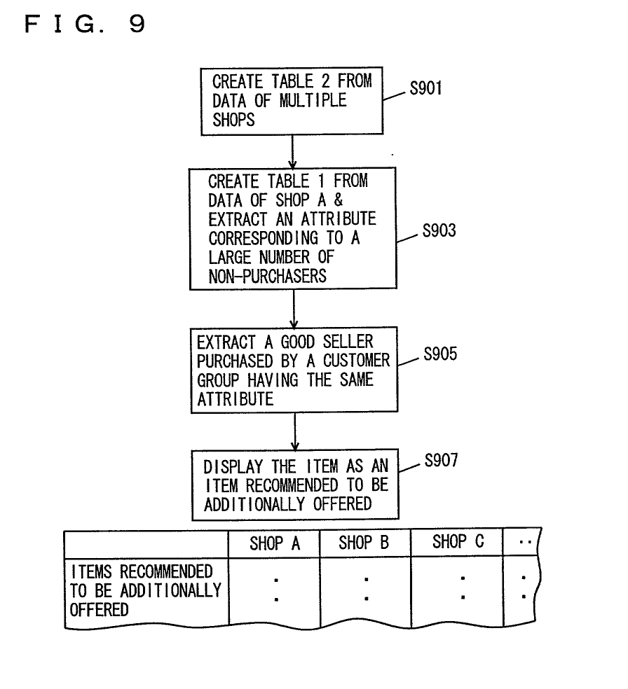

Information analysis center 200 uses the FIGS. 7 and 8 lists to provide a data analysis, by way of example, as will now be described with reference to FIGS. 9-14.

FIG. 9 is a flow chart representing a first analysis procedure focusing on a group of non-purchasers to analyze for each shop which item is recommendable to be additionally offered. With reference to the figure, information analysis center 200 counts data transmitted from the plurality of shops 100 and initially create a data table corresponding to Table 2 shown in FIG. 8 (step S901). Only the data of a target shop is then used to create a data table corresponding to Table 1 shown in FIG. 7 and an attribute corresponding to a large number of non-purchasers is extracted from the table (step S903). Note that the “Table 1” referred to herein is a table having each column only indicating a number of people, as has been described with reference to FIG. 7 (and will also similarly apply hereinafter).

Then from a data table corresponding to Table 2 previously created is extracted a good seller purchased by a customer group having the attribute extracted at step S903 (step S905). That is, from the table is extracted an item purchased in a shop other than the target shop by a group of purchasers having the same attribute as a group of non-purchasers in the target shop. The extracted item is presented as an item recommended to be additionally offered (step S907). Thus the group of non-purchasers in the target shop can be shifted to purchasers.

By providing the above analysis for each shop, an item recommended to be additionally offered is extracted for the shop. Then, as shown in the figure, resultant extractions are listed and displayed. From this list a user can determine an item to be additionally offered.

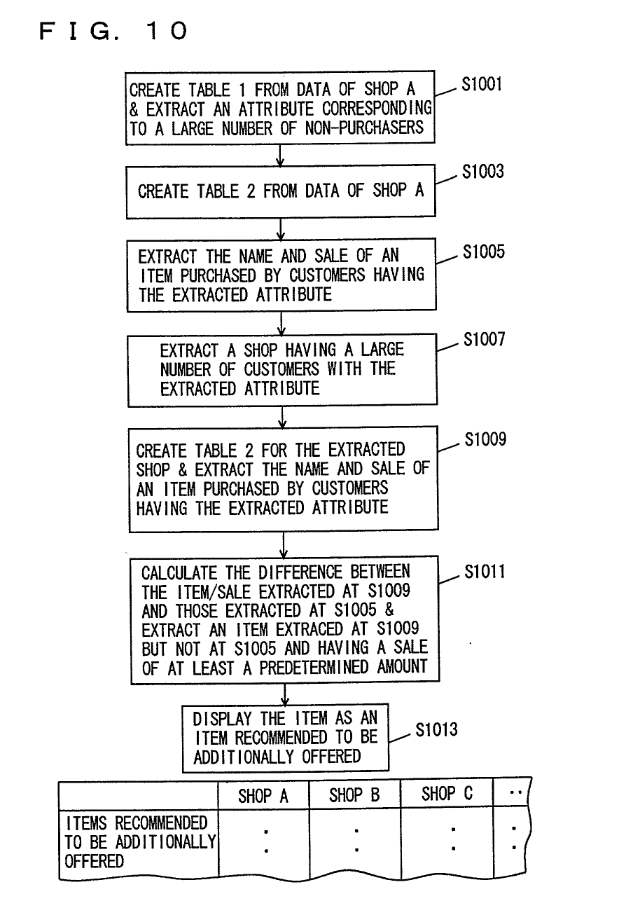

FIG. 10 shows a flow chart of a second analysis procedure focusing on a group of non-purchasers to analyze for each shop which item is recommendable to be additionally offered. With reference to the figure, information analysis center 200 receives data from the plurality of shops 100 and therefrom counts the data of a target shop and creates a data table corresponding to Table 1 shown in FIG. 7 and from the table extracts an attribute corresponding to a large number of non-purchasers in the shop (step S1001).

Then from the data of the target shop is created a data table corresponding to Table 2 shown in FIG. 8 (step S1003). From the data table is extracted the name and sale of an item purchased by customers having the attribute extracted at step S1001 (step S1005).

Then is extracted a shop other than the target shop that has a large number of customers having the attribute extracted at step S1001 (step S1007). Then for the extracted shop a data table corresponding to Table 2 is created and from the data table is extracted the name and sale of an item purchased by customers having the attribute extracted as described above (step S1009).

Then is calculated the difference between the item (and its sale) extracted at step S1009 and the item (and its sale) extracted at step S1005. Then an item extracted at step S1009 but not at step S1005 that sells more than a predetermined amount, is extracted (step S1011) and displayed as an item recommended to be additionally offered in the target shop (step 1013).

The process described above can be summarized, as follows: initially, there is extracted a shop other than the target shop that has a purchaser group having the same attribute(s) as an attribute(s) of a non-purchaser group of a target shop and there is then extracted an item purchased by the purchaser group of the extracted shop having the attribute. Then, of the extracted items, an item that is currently not offered in the target shop is presented as an item recommended to be additionally offered therein. It is highly probable that the non-purchaser group of the target shop will purchase the item recommended to be offered and the non-purchaser group can thus be shifted to a purchaser group. Furthermore, any items already offered in the target shop are not presented as those recommended to be additionally offered and more precise contents can thus be displayed.

Such an analysis is provided for each shop and an item recommended to be additionally offered is extracted for the shop. Then, as shown in the figure, resultant extractions are indicated in the form of a list. The list is presented to a user and from the list the user can determine which item should be additionally offered.

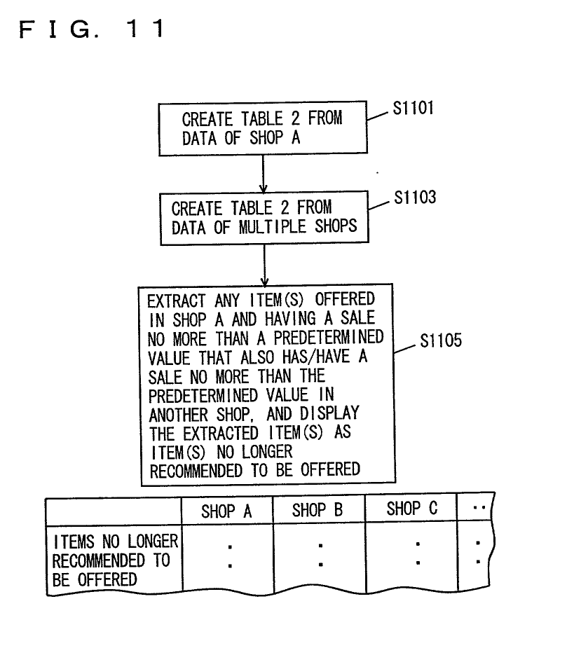

On the other hand, which item is no longer recommendable to be offered is analyzed for each shop, as will now be described by way of example. FIG. 11 is a flow chart of a procedure analyzing for each shop which item is no longer recommendable to be offered. With reference to the figure, information analysis center 200 receives data from the plurality of shops 100 and counts the data of a target shop and creates a data table corresponding to Table 2 shown in FIG. 8 (step S11O1). Then the data of all of shops 100 are counted and a data table corresponding to Table 2 is similarly created (step S103). Then from the table created at step S101 (the corresponding data table) is extracted any items having their respective sales smaller than a value. Then, of such items are extracted any items in the table created at step S1103 (the corresponding data table) that have a sale smaller than a predetermined amount. The extracted items are displayed as those no longer recommendable to be offered in the target shop (step S1105).

The analysis as described above is provided for each shop to create for the shop a list of items no longer recommendable to be offered, as shown in the figure.

Thus the data of all of the shops are counted and a result thereof is referred to to appropriately extract an item no longer recommendable to be offered in each shop.

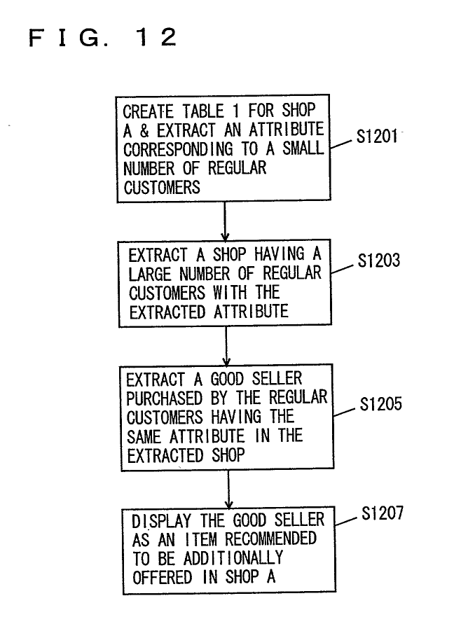

An example of an analysis provided to shift a new customer to a regular customer will now be described. FIG. 12 is a flow chart representing a first analysis procedure focusing on the regular customer/new customer information to analyze for each shop which item is recommendable to be additionally offered in the shop.

With reference to the figure, information analysis center 200 receives data from the plurality of shops 100 and from the received data counts the data of a target shop and creates a data table corresponding to Table 1 shown in FIG. 7. Then from this data table is extracted an attribute corresponding to a small number of regular customers (step S1201).

Then a data table corresponding to Table 1 is created also for each shop other than the target shop. The created tables corresponding to Table 1 are used to extract a shop having a large number of regular customers with the attribute extracted at step S1201 (step S1203). Then is extracted the name of a good seller purchased by the regular customers in the extracted shop (step S1205).

The extracted item is displayed as an item recommended to be additionally offered in the target shop (step S1207). By providing the above analysis for each shop, an item recommended to be additionally offered can be presented for the shop.

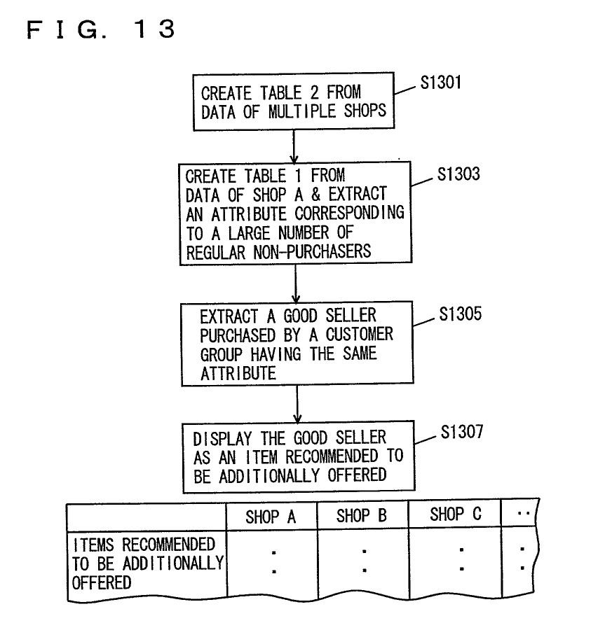

FIG. 13 is a flow chart representing a second analysis procedure focusing on the regular customer/new customer information to analyze for each shop which item is recommendable to be additionally offered in the shop. With reference to the figure, information analysis center 200 receives and counts data transmitted from the plurality of shops 100 and initially creates a data table corresponding to Table 2 shown in FIG. 8 (step S1301). Then from the data of a target shop a data table corresponding to Table 1 shown in FIG. 7 is created and from the Table 1 data table an attribute corresponding to a large number of regular non-purchasers is extracted (step S1303).

Then, from the data table previously created to correspond to Table 2, a good seller purchased by a customer group having the attribute extracted at step S1303, is extracted (step S1305). More specifically, a good seller purchased by a customer group having the same attribute(s) as a group of a large number of regular non-purchasers in the target shop, is extracted and presented as a recommended item (step S1307). Thus the regular non-purchaser group of the target shop can be shifted to a purchaser group.

By providing the above process for each shop, an item recommended to be additionally offered is extracted for the shop. Then, as shown in the figure, resultant extractions are displayed in a list to a user and from the list the user can determine an item to be additionally offered that has a potential to urge regular customers to purchase the item more frequently.

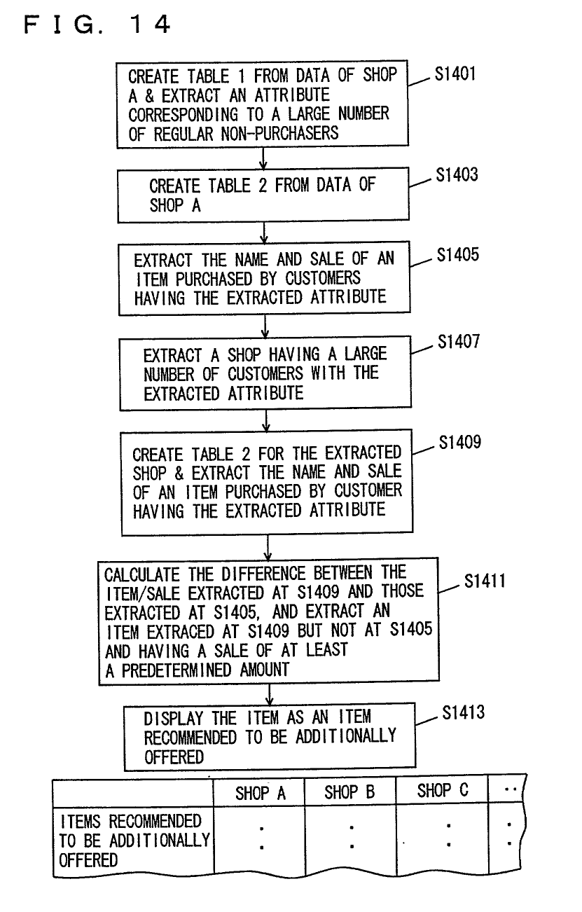

Reference will now be made to FIG. 14 to show a flow chart of a third analysis procedure focusing on the regular customer/new customer information to analyze for each shop which item is recommendable to be additionally offered. With reference to the figure, information analysis center 200 receives data transmitted from the plurality of shops 100 and initially counts the data of a target shop and creates a data table corresponding to Table 1 shown in FIG. 7. Then from the Table 1 data table is extracted an attribute observed in the shop that corresponds to a large number of regular non-purchasers (step S1401).

Then from the data of the target shop is created a data table corresponding to Table 2 shown in FIG. 8 (step S1403). From the data table is extracted the name and sale of an item purchased by customers having the attribute extracted at step S1401 (step S1405).

Then is extracted a shop other than the target shop that has a large number of customers having the attribute extracted at step S1401 (step S1407). Then for the extracted shop a data table corresponding to Table 2 is created and from the data table is extracted the name and sale of an item purchased by the customers having the attributed extracted as described above (step S1409).

Then is calculated a difference between the item (and its sale) extracted at step S1409 and the item (and its sale) extracted at step S1405. Then, any item(s) extracted at step S1409 but not at step S1405 that sell more than a predetermined amount, are extracted (step S1411) and displayed as those recommended to be additionally offered in the target shop (step S1413).

The above process flows, as summarized below: initially, there is extracted a shop other than the target shop that has a large number of purchasers having the same attribute(s) as observed in a group of large number of regular, non-purchasers in a target shop, and then is extracted any item(s) purchased in the extracted shop by the purchaser group having the attribute. Then the extracted item(s) excluding those currently offered in the target shop are presented as items recommended to be additionally offered. It is highly probable that the regular, non-purchaser group in the target shop will purchase the items recommended to be additionally offered. Thus the customers of the regular, non-purchaser group can be shifted to a purchaser group. Furthermore, any item(s) already offered in the target shop are not presented as items recommended to be additionally offered and more precise contents can thus be displayed.

Such an analysis is provided for each shop and an item recommended to be additionally offered is extracted for the shop. Then, as shown in the figure, resultant extractions are indicated in the form of a list to a user and from the list the user can determine an item to be additionally offered to shift a regular customer group less frequently purchasing items to a customer group frequently purchasing items.

The customer information management (and information analysis) method presented herein can be implemented by a program provided to allow the above-described, series of operations to function. The customer information management program may be installed previously in a customer information management system or a hard disk in a computer of an information analysis center or it may be recorded in a removable recording medium, such as a CD-ROM, a magnetic tape or the like. At any rate, the customer information management program is recorded in a computer-readable recording medium.

Note that the computer-readable recording medium can be a magnetic tape, a cassette tape or any other similar tape, a magnetic disk (such as a flexible disk device or a hard disk device), an optical disk (such as a CD-ROM, an MO, an MD, a DVD or the like) or any other similar disk, an IC card (including a memory card), an optical card or any other similar card, a mask ROM, an EPROM, an EEPROM, a flash ROM or any other similar semiconductor memory, or any other similar media carrying a program thereon in a fixed manner.

Alternatively it may be a medium carrying a program thereon in a variable manner to allow a program to be downloaded from a network.

Note that the recording medium may store data, rather than a program.

In FIGS. 9 and 13, whether or not a purchase is effected in a target shop, an item recommended to be additionally offered is extracted from Table 2 shown in FIG. 8 created from the data of all of the shops (the corresponding data table). However, the analysis procedure is not thus limited and for example as shown in FIG. 10 or 14 an item recommendable to be additionally offered may be extracted from a difference from an item purchased in the target shop. Since any items already offered in the target shop are excluded from items recommended to be additionally offered, only the exact item(s) that are necessary can be indicated and thus efficiently presented.

In contrast, the difference from an item purchased in the target shop may not be calculated in FIGS. 10 and 14. More specifically, as shown in FIG. 9 or 13, a good seller purchased in a shop by a group of a large number of customers having a predetermined attribute, may be presented as an item recommended to be additionally offered. Thus a simple analysis can be used to extract an item appropriately recommended to be additionally offered.

Note that the FIGS. 9-14 analysis procedures can be used, as appropriate, to accommodate different conditions. For example, in response to a request from a user in each shop 100 a selected analysis procedure is implemented in information analysis center 200.

It should also be noted that while in the present embodiment information analysis center 200 provides a data analysis, each shop may alternatively provide an analysis, as required.

Also note that while in the FIGS. 3 and 5 the customer DB stores data including image data of a customer image-sensed and data of the customer transmitted to information analysis center 200, as shown in FIGS. 4A and 4B and 6A and 6B, if each shop does not provide a data analysis then it is not required to store all of the data of the customer and may only store data required for matching an image of the customer when the customer is entering or leaving the shop.

Furthermore, while herein image data of a customer image-sensed with a camera is correlated with an attribute or the like and thus stored in the visitor DB and the customer DB, data indicating a feature of the customer (feature data) may replace image data and be stored. Data indicating a feature is data required in matching an image with another and it is extracted from image data of a customer.

Recording feature data correlated with a customer allows a smaller memory capacity to be used than when the entirety of an image is recorded. Thus the customer DB can be used efficiently. Since feature data is used for matching, a more precise matching process can be provided. Furthermore, feature data cannot be used to restore an image of the face of a customer and the customer's privacy can also be protected.

Also note that while in the present embodiment a customer is image-sensed in a shop at an entrance, a cash desk and an exit for a total of three locations, as shown in FIG. 1, if it is not necessary to know how long the customer has stayed in the shop then the customer may be image-sensed in the shop at the entrance and the cash desk or at the cash desk and the exit, for a total of two locations.

Imaging at the two locations allows an image-matching and other required information can be obtained. More specifically, if a customer is image-sensed at the entrance and the cash desk, whether or not the customer is a non-purchaser can be determined from time information stored in the visitor DB. Since the information of a customer coming to the cash desk to purchase an item is deleted from the visitor DB, a customer remaining for a predetermined period of time can be considered as a non-purchaser. If customers are image-sensed in a shop at a cash desk and an exit then a customer leaving the shop through the exit can be determined as a non-purchaser if the customer does not match any customer having purchased an item at the cash desk.

Thus, image-sensing at the two locations allows a simple configuration to be used to manage and analyze customer information.

Also note that in the present embodiment, as shown for example in FIG. 2 at step S203, how frequently a customer came to a shop during a predetermined, previous temporal period, is referred to to determine whether the customer is a regular customer or a new customer. Alternatively, in addition to determining a customer as a regular customer or a new customer, how frequently the customer comes to the shop as a regular customer or a new customer, may be considered to provide a level to the customer, as compared with other regular customers or other new customers, respectively.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A customer information management system comprising:
a first acquisition block obtaining image information of a customer having purchased an item;
an attribute determination block determining a first attribute of said customer from said image information obtained;
a second acquisition block obtaining data of said item purchased by said customer; and
a recording block recording said data of said item obtained and said first attribute of said customer determined, said data and said first attribute being correlated with each other.

2. The customer information management system of claim 1, wherein said recording block further records a second attribute of said customer, said second attribute being correlated with said data of said item obtained, said second attribute being determined through a human perception.

3. The customer information management system of claim 1, further comprising an analysis block using said data of said item recorded and said attribute of said customer to provide a data analysis.

4. The customer information management system of claim 3, wherein said data analysis includes one of a data analysis about the attribute for each item and a data analysis about the item data for each purchaser attribute.

5. A customer information management method comprising the steps of:
obtaining image information of a customer having purchased an item;
determining a first attribute of said customer from said image information obtained;
obtaining data of said item purchased by said customer; and
recording said data of said item obtained and said first attribute of said customer determined, said data and said first attribute being correlated with each other.

6. A computer-readable recording medium having recorded therein a customer information management program causing a computer to execute the steps of:
obtaining image information of a customer having purchased an item;
determining a first attribute of said customer from said image information obtained;
obtaining data of said item purchased by said customer; and
recording said data of said item obtained and said first attribute of said customer determined, said data and said first attribute being correlated with each other.

7. A customer information management system comprising:
a first image acquisition block obtaining image information of a customer entering a shop;
a second image acquisition block obtaining image information of a customer having purchased an item;
a first extraction block referring to said image information obtained by said first image acquisition block and said image information obtained by said second image acquisition block, to extract image information obtained exclusively by said first image acquisition block and absent from said second image acquisition block;
an attribute acquisition block obtaining an attribute of a customer corresponding to said image information extracted; and
a recording block recording information indicative of a non-purchaser and said attribute obtained, said information and said attribute being correlated with each other.

8. The customer information management system of claim 7, wherein said attribute acquisition block includes a first determination block determining on the basis of said image information extracted said attribute of said customer corresponding to said image information extracted.

9. The customer information management system of claim 7, further comprising:
an item data acquisition block obtaining data of said item purchased by said customer corresponding to said image information obtained by said second image acquisition block; and
a second determination block determining an attribute of said customer on the basis of said image information obtained by said second image acquisition block,
wherein said recording block further records information indicative of a purchaser, said data of said item obtained, and said attribute determined by said second acquisition block, said information, said data and said attribute being correlated with each other.

10. The customer information management system of claim 7, further comprising an analysis block providing a data analysis based on data recorded in said recording block.

11. The customer information management system of claim 10, wherein said data analysis includes a data analysis about an item data for each purchaser attribute and a data analysis about an attribute for each of a purchaser and a non-purchaser.

12. The customer information management system of claim 10, wherein if said recording block records data received from a plurality of shops said analysis block uses said data of said plurality of shops recorded in said recording block to provide a data analysis to develop a strategy for each shop.

13. A customer information management method comprising the steps of:
obtaining image information of a customer entering a shop;
obtaining image information of a customer having purchased an item;
comparing said image information obtained in the step of obtaining said image information of said customer entering said shop and said image information obtained in the step of obtaining said image information of said customer having purchased said item, and extracting image information obtained exclusively in the step of obtaining said image information of said customer entering said shop;
obtaining an attribute of a customer corresponding to said image information extracted; and
for said customer corresponding said image information extracted, recording information indicative of a non-purchaser and said attribute obtained, said information and said attribute being correlated with each other.

14. A computer-readable recording medium having recorded therein a customer information management program causing a computer to execute the steps of:
obtaining image information of a customer entering a shop;
obtaining image information of a customer having purchased an item;
comparing said image information obtained in the step of obtaining said image information of said customer entering said shop and said image information obtained in the step of obtaining said image information of said customer having purchased said item, and extracting image information obtained exclusively in the step of obtaining said image information of said customer entering said shop;
obtaining an attribute of a customer corresponding to said image information extracted; and
for said customer corresponding to said image information extracted, recording information indicative of a non-purchaser and said attribute obtained, said information and said attribute being correlated with each other.

15. A customer information management system comprising:
a recording block recording image information of a customer of a shop and a frequency of said customer's appearance in said shop, said image information and said frequency being correlated with each other;
an acquisition block obtaining image information of a customer entering said shop;
a comparison block comparing said image information recorded in said recording block and said image information obtained with each other to determine whether said image information match each other;
an increment block incrementing by one a frequency of appearance in said shop recorded and corresponding to said image information recorded in said recording block and matching said image information obtained; and
an addition block adding to said recording block said image information obtained, if a comparison made by said comparison block reveals that said recording block does not have image information matching said image information obtained.

16. The customer information management system of claim 15, further comprising a determination block referring to said frequency recorded in said recording block, to determine whether said customer is a regular customer or a new customer, said determination block determining that said customer is a regular customer if said frequency has at least a predetermined value for a predetermined period of time, said determining block determining that said customer is a new customer if said frequency is less than said predetermined value for said predetermined period of time.

17. The customer information management system of claim 15, further comprising an extraction block extracting feature data from image data of a customer image-sensed, wherein said image information obtained by said acquisition block is said feature data extracted by said extraction block.

18. The customer information management system of claim 15, further comprising an item data acquisition block obtaining data of an item purchased by a customer, wherein said recording block further records said data of said item obtained, said data being correlated with said image information of said customer and said frequency.

19. The customer information management system of claim 15, further comprising an analysis block providing a data analysis based on data recorded in said recording block.

20. The customer information management system of claim 19, wherein said data analysis includes a data analysis about the item data for each of regular and new customers.

21. The customer information management system of claim 19, wherein if said recording block records data received from a plurality of shops, said analysis block uses said data of said plurality of shops in said recording block to provide said data analysis to develop a strategy for each shop.

22. A customer information management method comprising the steps of:
recording image information of a customer of a shop and a frequency of said customer's appearance in said shop, said image information and said frequency being correlated with each other;
obtaining image information of a customer entering said shop;
comparing said image information recorded in the step of recording and said image information obtained with each other to determine whether said image information match each other;
incrementing by one a frequency of appearance in said shop recorded and corresponding to said image information recorded in the step of recording and found to match said image information obtained; and
adding to said recording block said image information obtained, if a comparison made in the step of comparing reveals that said image information recorded in the step of recording do not include image information matching said image information obtained.

23. A computer-readable recording medium having recorded therein a customer information management program causing a computer to execute the steps of:
recording image information of a customer of a shop and a frequency of said customer's appearance in said shop, said image information and said frequency being correlated with each other;
obtaining image information of a customer entering said shop;
comparing said image information recorded in the step of recording and said image information obtained with each other to determine whether said image information match each other;
incrementing by one a frequency of appearance in said shop recorded and corresponding to said image information recorded in the step of recording and found to match said image information obtained; and
adding to said recording block said image information obtained, if a comparison made in the step of comparing reveals that said image information recorded in the step of recording do not include image information matching said image information obtained.

24. A customer information management system comprising:
a camera image-sensing a customer in a shop to generate an image signal indicating an image of said customer;
a first processor receiving said image signal to determine an attribute of said customer on the basis of said image;
a first input unit receiving information of an item purchased in the shop by said customer; and
a first storing section storing said information of said item received and said attribute of said customer determined, said information and said attribute being correlated with each other.

25. The customer information management system of claim 24, wherein said camera is arranged at a predetermined position and image-senses said customer at a predetermined timing.

26. The customer information management system of claim 24, wherein said position is suitable for image-sensing a face of said customer.

27. The customer information management system of claim 24, wherein said attribute includes at least one of sex and age.

28. The customer information management system of claim 24, wherein said information of said item includes a name of said item.

29. The customer information management system of claim 24, wherein said camera, said first processor, said first input unit and said first storing section are installed inside said shop.

30. The customer information management system of claim 24, further comprising a second input unit receiving an attribute of said customer, wherein said first storing section further stores an attribute input via a second input unit and different from said attribute determined in said first processor.

31. The customer information management system of claim 24, further comprising a second processor providing a data analysis based on said information of said item recorded and said attribute of said customer, wherein said camera, said first processor, said first input unit and said first storing section are arranged inside said shop as an internal device and said second processor is arranged outside said shop and capable of communicating with said internal device.

32. The customer information management system of claim 24, wherein:
said camera includes a first camera image-sensing a customer having entered said shop and a second camera image-sensing a customer having purchased an item;
said first processor receives said image signal generated by said first camera and an image signal generated by said second camera, to determine an attribute of a customer having an image indicated by an image signal generated by said first camera but not by any image signal generated by said second camera; and
said first storing section further stores information indicating that said customer is a non-purchaser, said information being added to said attribute of said customer determined.

33. The customer information management system of claim 32, wherein said first camera is positioned in a vicinity of an entrance of said shop and said second camera is positioned in a vicinity of a cash desk of said shop.

34. The customer information management system of claim 24, wherein:
said camera includes a first camera image-sensing a customer having entered said shop and a second camera image-sensing a customer having purchased an item;
said first processor receives said image signal generated by said first camera and an image signal generated by said second camera, to determine an attribute of a customer having an image indicated by an image signal generated by said first camera but not by any image signal generated by said second camera; and
said first storing section further stores information indicating that said customer is a purchaser, said information being added to said attribute of said customer determined.

35. The customer information management system of claim 24, further comprising:
a second recording block recording an image signal representative of a customer of a shop and a frequency of said customer's appearance in said shop, said image signal representative of said customer and said frequency being correlated with each other; and
a third processor incrementing by one said frequency correlated with said image signal recorded in said second recording block and found to match said image signal generated by said camera.

36. The customer information management system of claim 35, wherein said third processor additionally records in said second recording block said image signal of said customer generated by said camera if said image signal of said customer generated by said camera is not present in said second recording block.
